(19) United States
(12) Patent Application Publication
(10) Pub. No.: US 2020/0186729 A1
(43) Pub. Date: Jun. 11, 2020

(54) IMAGE PROCESSING APPARATUS, IMAGE PROCESSING METHOD, PROGRAM, AND REMOTE COMMUNICATION SYSTEM

(71) Applicant: SONY CORPORATION, Tokyo (JP)

(72) Inventor: Masato AKAO, Kanagawa (JP)

(73) Assignee: SONY CORPORATION, Tokyo (JP)

(21) Appl. No.: 16/631,748

(22) PCT Filed: Jul. 17, 2018
(86) PCT No.: PCT/JP2018/026656

§ 371 Date: Jan. 16, 2020

(30) Foreign Application Priority Data
Jul. 31, 2017 (JP) 2017-147338

(51) Int. Cl. H04N 5/262; G06K 9/00; G06T 15/04; G06T 17/00; G06T 19/20; H04N 7/14; H04N 5/265

(52) U.S. Cl. CPC H04N 5/2628; G06K 9/00228; G06T 15/04; G06T 17/00; G06T 2219/2004; H04N 7/147; H04N 5/265; G06T 2219/2016; G06T 19/20

(57) ABSTRACT

The present disclosure relates to an image processing apparatus, an image processing method, a program, and a remote communication system that are able to provide a good user experience with a less calculation amount. A face region in which a face of a user is captured and a body region in which a body of the user is captured are detected from an image obtained by imaging of the user who faces a front side of a display unit by an imaging unit from a direction other than the front side. Then, a front face image in which the face of the user is imaged from the front side is generated on the basis of the face region, correction to a front body image in which the body of the user is imaged from the front side is performed on the basis of the body region, and the front face image and the front body image are combined.

### TECHNICAL FIELD

The present disclosure relates to an image processing apparatus, an image processing method, a program, and a remote communication system, and in particular, to an image processing apparatus, an image processing method, a program, and a remote communication system that are able to provide a good user experience with a less calculation amount.

### BACKGROUND ART

Typically, a remote communication system that allows users who stay at places away from each other to perform communication like face-to-face communication with each other has been developed. In such a remote communication system, by displaying images in which each user faces the front side, for example, it is possible for the users to have eye contact with each other or for the users to respectively have postures at which the users face to each other. With this system, it is possible to provide a good user experience to the user who performs remote communication.

For example, PTL 1 discloses a communication system that is able to display an image which is viewed as if persons having a conversation have eye contact with each other by perspective correction even in a case where the persons having a conversation are not directly face display surfaces. Furthermore, PTL 2 discloses a communication system that is able to display an image in which the user is viewed as if the user faces the front side by generating three-dimensional data and attaching a texture on a surface of a three-dimensional model.

### CITATION LIST

### Patent Literature

PTL 1: Japanese Unexamined Patent Application Publication No. 2011-97447

PTL 2: Japanese Unexamined Patent Application Publication No. 2014-86773

### SUMMARY OF THE INVENTION

### Problems to be Solved by the Invention

By the way, the technology disclosed in PTL 1 has not coped with a full-length figure, and it has been difficult for users to have eye contact with each other in a case where the technology is applied to a large screen. Furthermore, according to the technology disclosed in PTL 2, a calculation amount is enormously increased, and in addition, it has been necessary to provide depth information with high accuracy. Therefore, it has been necessary to provide an apparatus having high performance.

The present disclosure has been made in view of such a situation and allows to provide a good user experience with a less calculation amount.

### Means for Solving the Problems

An image processing apparatus according to one embodiment of the present disclosure includes: a detector that detects, from an image obtained by imaging of a user who faces a front side of a display unit by an imaging unit from a direction other than the front side, a face region in which a face of the user is captured and a body region in which a body of the user is captured, in which the display unit is configured to display an image; a front face generator that generates, on the basis of the face region, a front face image in which the face of the user is imaged from the front side; a body corrector that performs, on the basis of the body region, correction into a front body image in which the body of the user is imaged from the front side; and a combination unit that combines the front face image and the front body image.

An image processing method or a program according to one embodiment of the present disclosure includes: detecting, from an image obtained by imaging of a user who faces a front side of a display unit by an imaging unit from a direction other than the front side, a face region in which a face of the user is captured and a body region in which a body of the user is captured, in which the display unit is configured to display an image; generating, on the basis of the face region, a front face image in which the face of the user is imaged from the front side; performing, on the basis of the body region, correction into a front body image in which the body of the user is imaged from the front side; and combining the front face image and the front body image.

A remote communication system according to one embodiment of the present disclosure includes: a communication unit that performs transmission and reception of at least an image with a partner of a communication; a display unit that displays the image transmitted from a side of the partner; an imaging unit that performs imaging of a user who faces a front side of the display unit from a direction other than the front side; a detector that detects, from an image obtained by the imaging of the user by the imaging unit, a face region in which a face of the user is captured and a body region in which a body of the user is captured; a front face generator that generates, on the basis of the face region, a front face image in which the face of the user is imaged from the front side; a body corrector that performs, on the basis of the body region, correction into a front body image in which the body of the user is imaged from the front side; and a combination unit that combines the front face image and the front body image.

In one embodiment of the present disclosure, the face region in which the face of the user is captured and the body region in which the body of the user is captured are detected from the image that is obtained by the imaging of the user who faces the front side of the display unit that displays the image by the imaging unit from the direction other than the front side. The front face image in which the face of the user is imaged from the front side is generated on the basis of the face region, the correction to the front body image in which the body of the user is imaged from the front side is performed on the basis of the body region, and the front face image and the front body image are combined.

### Effects of the Invention

According to one embodiment of the present disclosure, it is possible to provide a good user experience with a less calculation amount.

Note that the effects described here are not necessarily limited and may be any effect described in the present disclosure.

### BRIEF DESCRIPTION OF DRAWING

FIG. 1 is a block diagram illustrating an example of a configuration according to one embodiment of a remote communication system to which the technology is applied.

FIG. 2 is a block diagram illustrating a configuration of a communication processor.

FIG. 3 is a flowchart for explaining remote communication processing.

FIG. 4 is a diagram for explaining an example in which image processing is separately executed on a front face image and a front body image.

FIG. 5 is a flowchart for explaining a first processing example of person image synthesis processing.

FIG. 6 is a diagram for explaining processing for separately performing perspective correction on upper limbs or lower limbs.

FIG. 7 is a flowchart for explaining a second processing example of the person image synthesis processing.

FIG. 8 is a diagram for explaining processing when a plurality of persons is captured.

FIG. 9 is a flowchart for explaining a third processing example of the person image synthesis processing.

FIG. 10 is a block diagram illustrating an example of a configuration according to one embodiment of a computer to which the technology is applied.

### MODES FOR CARRYING OUT THE INVENTION

A specific embodiment to which the technology is applied will be described in detail below with reference to the drawings.

### EXAMPLE OF CONFIGURATION OF REMOTE COMMUNICATION SYSTEM

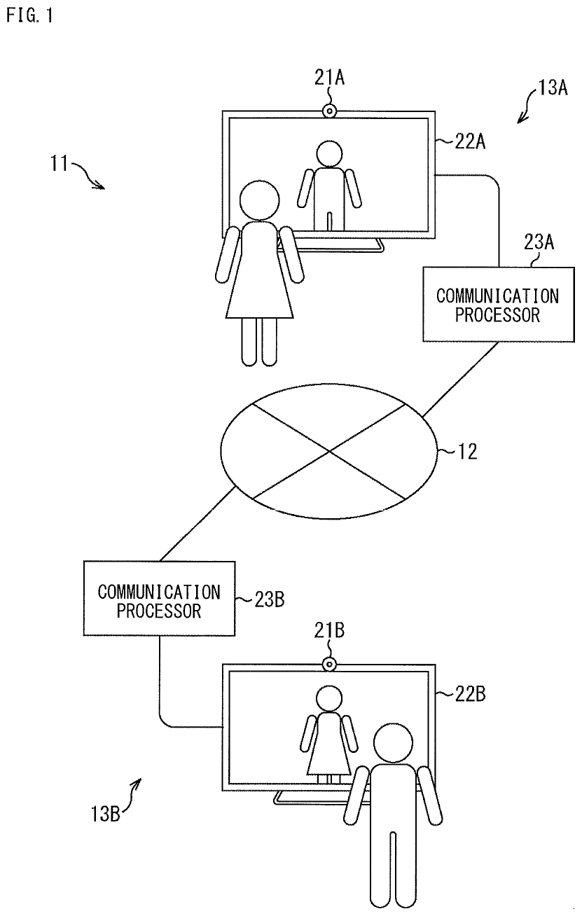

FIG. 1 is a block diagram illustrating an example of a configuration according to one embodiment of a remote communication system to which the technology is applied.

As illustrated in FIG. 1, a remote communication system 11 is coupled to communication terminals 13A and 13B provided at remote places via a network 12 such as the Internet.

For example, in the remote communication system 11, it is possible for the communication terminals 13A and 13B to transmit and receive images and sound in a mutual fashion in real time by remotely communicating to each other via the network 12. This enables a user A who stays on the side of the communication terminal 13A and a user B who stays on the side of the communication terminal 13B to have a conversation with each other as a face-to-face conversation, and it is possible to have more realistic communication.

Note that the communication terminals 13A and 13B are similarly configured. In a case where it is not necessary to distinguish the communication terminals 13A and 13B from each other, each of the communication terminals 13A and 13B is simply referred to as a communication terminal 13. The same applies to each unit included in the communication terminals 13A and 13B. Furthermore, a user who stays on the side of the communication terminal 13 (for example, user A relative to communication terminal 13A and user B relative to communication terminal 13B) is referred to as an own-side user. Then, a user who is a communication partner of the above user (for example, user B relative to communication terminal 13A and user A relative to communication terminal 13B) is referred to a partner-side user.

The communication terminal 13 includes a sensor unit 21, a presentation unit 22, and a communication processor 23.

The sensor unit 21 includes, for example, an imaging device that performs imaging of a user in front of the presentation unit 22, a depth sensor that acquires depth information in an imaging range of the imaging device, and a voice input device such as a microphone that inputs user's voice. Then, the sensor unit 21 supplies an image signal obtained by imaging the own-side user, the depth information obtained by detecting a depth of the user having been subjected to the imaging, a voice signal obtained from voice of the own-side user, and the like to the communication processor 23 and causes the communication processor 23 to transmit the supplied signal to the partner-side communication terminal 13 via the network 12. Here, as a depth sensor, it is possible to use a TOF (Time Of Flight) sensor using reflection of infrared light or a stereo camera using a plurality of imaging devices.

The presentation unit 22 includes, for example, a display that displays an image in which the partner-side user is captured and a voice output device such as a speaker that outputs user's voice. For example, the image signal, the voice signal, and the like transmitted from the partner-side communication terminal 13 via the network 12 are supplied from the communication processor 23 to the presentation unit 22.

The communication processor 23 executes various processing necessary for communication, such as communication processing for communication via the network 12 or image processing for good communication between the users.

For example, in the communication terminal 13, as illustrated, the imaging device included in the sensor unit 21 is disposed on an upper side of the display included in the presentation unit 22. The sensor unit 21 performs imaging of the user in front of the presentation unit 22 from above. Therefore, in an image obtained by imaging the user by the sensor unit 21 disposed at such a position, the user who does not face the front side is captured. That is, since the user is imaged from the above as being looking down, for example, the users are not able to have eye contact with each other, and remote communication is performed by using an image with discomfort feeling such that the users are captured as having postures different from a posture viewed from the front side.

Therefore, it is possible for the communication processor 23 to execute image processing for synthesizing images (hereinafter, referred to as person image synthesis processing) by using the image signal and the depth information supplied from the sensor unit 21 to allow for formation of an image in which the entire body of the user has a posture that faces the front side and the face of the user is captured as facing the front side with high accuracy. Here, the image in which the face of the user faces the front side with high accuracy is, for example, an image in which the face of the user is captured as facing the front side to an extent that allows the partner-side user to recognize that the partner-side user catches the eyes of the own-side user when the own-side user faces the front side. Therefore, the communication terminal 13 makes it possible for the user to realize remote communication by using an image with less feeling of discomfort and obtain a better user experience. Note that, in the following description, only processing regarding images of the communication processing executed by the communication terminal 13 will be described. Description of processing regarding voice is omitted.

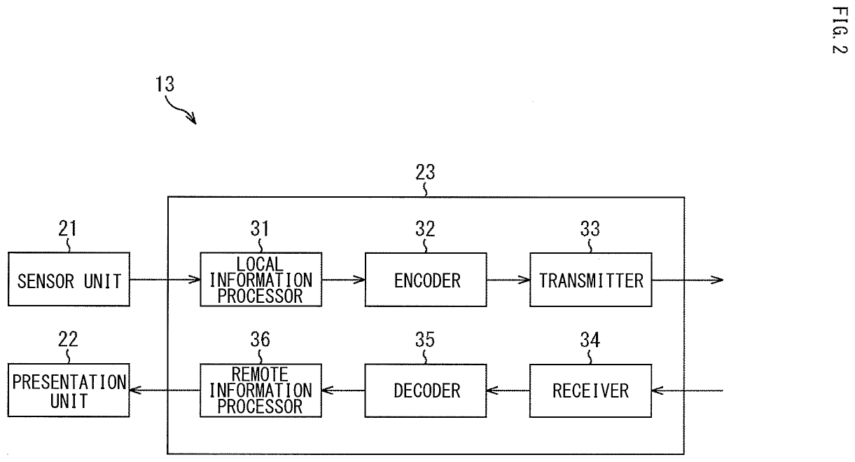

A configuration of the communication processor 23 will be described with reference to FIG. 2.

As illustrated in FIG. 2, the communication processor 23 includes a local information processor 31, an encoder 32, a transmitter 33, a receiver 34, a decoder 35, and a remote information processor 36.

When receiving the image signal and the depth information from the sensor unit 21, the local information processor 31 executes various processing on an image in which the own-side user is captured (hereinafter, referred to as local information processing). For example, the local information processor 31 executes the person image synthesis processing for synthesizing images to allow for formation of an image in which the entire body of the user has a posture that faces the front side and the face of the user is captured as facing the front side with high accuracy, as the local information processing. Then, the local information processor 31 supplies the image signal on which the local information processing has been executed to the encoder 32.

The encoder 32 is, for example, a block conforming to a communication protocol such as H.320 or H.323. The encoder 32 encodes the image signal supplied from the local information processor 31 and supplies the encoded signal to the transmitter 33.

The transmitter 33 transmits the image signal encoded by the encoder 32 to the partner-side communication terminal 13 via the network 12.

The receiver 34 receives the image signal transmitted from the partner-side communication terminal 13 via the network 12 and supplies the received signal to the decoder 35.

The decoder 35 is a block conforming to the communication protocol similar to that of the encoder 32. The decoder 35 decodes the image signal supplied from the receiver 34 (the image signal encoded by the encoder 32 of the partner-side communication terminal 13) and supplies the decoded signal to the remote information processor 36.

When receiving the image signal from the decoder 35, the remote information processor 36 executes various processing on an image in which the partner-side user is captured (hereinafter, referred to as remote information processing) and supplies the image to the presentation unit 22 and causes the presentation unit 22 to display the image. For example, in a case where the person image synthesis processing has not been performed by the partner-side communication processor 23, the remote information processor 36 executes the person image synthesis processing as the remote information processing.

The communication processor 23 is configured as described above. By executing the person image synthesis processing by the local information processor 31 or the remote information processor 36, it is possible to display an image in which the face of the user faces the front side and the user has a posture as viewed from the partner-side user. By allowing the user to perform remote communication by using such an image, it is possible for the communication terminal 13 to provide a better user experience.

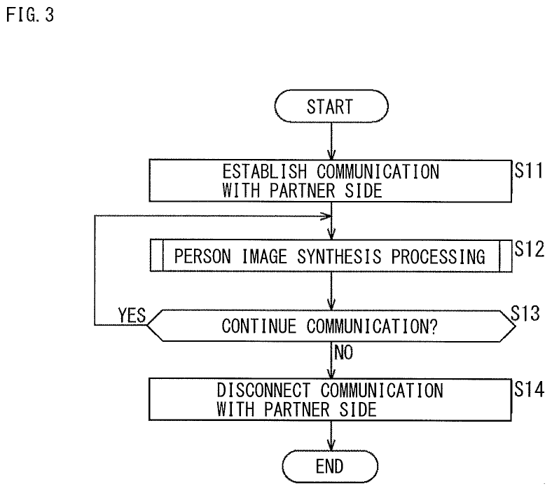

FIG. 3 is a flowchart for explaining remote communication processing executed by the communication terminal 13.

For example, when the communication terminal 13 is turned on and an application that performs the remote communication is activated, processing is started. The transmitter 33 and the receiver 34 execute processing for establishing communication with the partner-side communication terminal 13 in step S11. Then, when: communication between the communication terminals 13 is started; the sensor units 21 of the respective communication terminals 13 perform imaging of the users; and transmission and reception of images are performed, the image in which the user of the communication terminal 13 is captured is displayed on the partner-side presentation unit 22 in a mutual fashion.

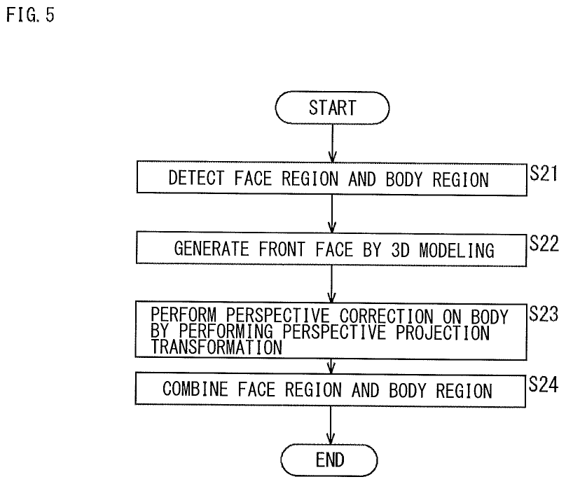

In step S12, for example, the local information processor 31 or the remote information processor 36 executes the person image synthesis processing (refer to FIG. 5) for synthesizing the images to allow for formation of an image in which the entire body of the user has a posture that faces the front side and the face of the user is captured as facing the front side with high accuracy.

In step S13, for example, it is possible for the communication processor 23 to determine whether or not to continue the communication on the basis of whether not an operation to terminate the remote communication is made relative to the application activated in step S11.

In a case where it is determined in step S13 to continue the communication, the processing returns to step S12, and thereafter, the similar processing is repeatedly executed. In contrast, in a case where it is determined in step S13 not to continue the remote communication, the processing proceeds to step S14. In step S14, the transmitter 33 and the receiver 34 execute processing for disconnecting the communication with the partner-side communication terminal 13 and terminate the communication.

### First Processing Example of Person Image Synthesis Processing

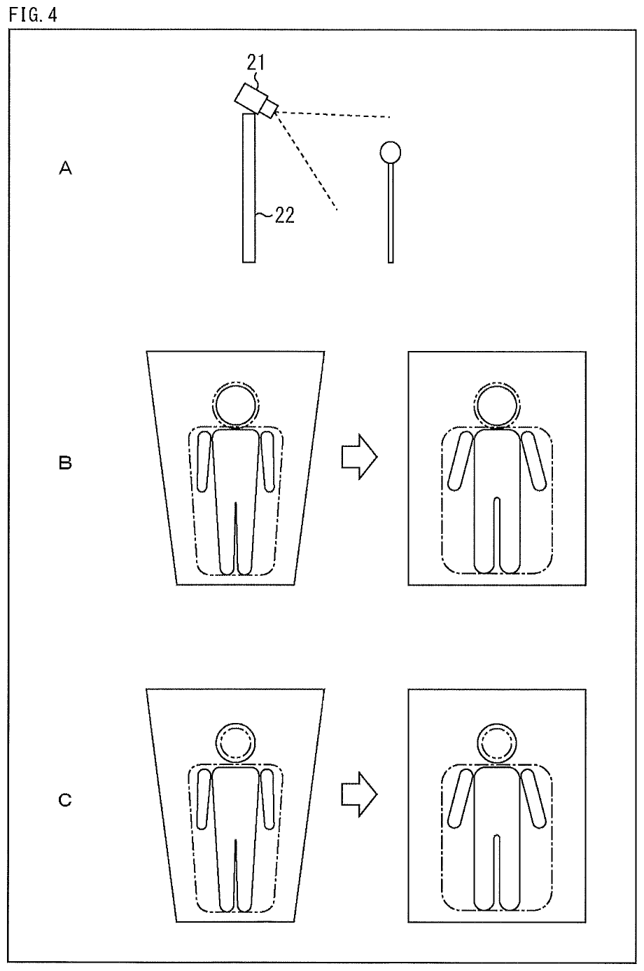

A first processing example of the person image synthesis processing will be described with reference to FIGS. 4 and 5.

For example, as illustrated in A of FIG. 4, when the imaging device of the sensor unit 21 disposed on the upper side of the display included in the presentation unit 22 performs the imaging of the user, as illustrated on the left side of B in FIG. 4, an image in which the user is looked down is captured. That is, the image is imaged in which the user has a posture at which the face of the user faces downward and the body gets narrower as it goes down.

With respect to such an image, in the person image synthesis processing, a face region in which the face of the user is captured (region surrounded by alternate long and two short dashes line) and a body region in which the body of the user is captured (region surrounded by alternate long and short dash line) are detected, and image processings using the respective face region and body region are separately executed.

For example, since human beings have high sensitivity to the direction of the face, regarding the face region, a front face image in which the face of the user is imaged from the front side is generated by performing 3D modeling. That is, after a 3D model of the face of the user is created by using the depth information on the basis of the face region and rotation processing is executed on the 3D model of the face to allow the face to face the front side, a texture of the face is attached. With this operation, a front face image having higher accuracy is generated. By executing such image processing, it is possible to generate a front face image with less feeling of discomfort as an image in which the face of the user is imaged from the front side to the extent, for example, that allows the partner-side user to recognize that the users have contact with each other when the own-side user looks at the front side.

On the other hand, since human beings have low sensitivity to the direction of the body, by performing perspective projection transformation, the perspective correction is performed on the body region to obtain a front body image in which the body of the user is imaged from the front side. For example, by using a parameter based on an angle between a direction in which a virtual imaging unit virtually disposed in front of the user images the user and a direction in which the sensor unit 21 images the user from the upper side as illustrated in A of FIG. 4, the perspective correction is performed as assuming that the body of the user is a plane as illustrated in A of FIG. 4. Note that the parameter used to perform the perspective correction may be manually adjusted. It is possible to statically or dynamically adjust the position of the virtual imaging unit with respect to a position of a subject (distance and position in horizontal direction). By executing such image processing, for example, it is possible to obtain a front body image in which the body of the user is imaged from the front side with a small calculation amount.

Then, by combining the front face image and the front body image obtained by separately executing the image processings, as illustrated on the right side in B of FIG. 4, it is possible to generate the image in which the entire body of the user has a posture that faces the front side and the face of the user is captured as facing the front side with high accuracy.

For example, the configuration that uses a large vertical display as the presentation unit 22 performs imaging of an image in which the entire body of the user is captured from a higher position. By executing the person image synthesis processing on such an image, it is possible to effectively generate the image in which the entire body of the user is captured in a posture that faces the front side by effectively performing the person image synthesis processing, particularly, on the body region.

Furthermore, regarding the processing for generating the front face image by 3D modeling with high accuracy, processing only on a region inside of an outline of the face (face inner region) as illustrated in C of FIG. 4 may be executed, in addition to processing on the entire face including the outline of the face as illustrated in B of FIG. 4. In this way, by using only the face inner region, it is possible to reduce a calculation amount of the processing for generating the front face image by 3D modeling with high accuracy than that in a case where the entire face is used. Furthermore, even in a case where the front face image is generated by using only the face inner region, it is possible to generate an image in which the face of the user faces the front side with high accuracy as in a case where the entire face is used.

FIG. 5 is a flowchart for explaining the first processing example of the person image synthesis processing executed in step S12 in FIG. 3. Note that, in the following description, a case will be described where the local information processor 31 executes the processing on an image in which the own-side user is captured. However, in a case where the remote information processor 36 executes the processing on an image in which the partner-side user is captured, similar processing is executed.

In step S21, the local information processor 31 recognizes a user captured in the image based on the image signal supplied from the sensor unit 21 and detects a face region and a body region of the user.

In step S22, the local information processor 31 generates a front face image with higher accuracy by performing 3D modeling using the depth information on the basis of the face region detected in step S21.

In step S23, the local information processor 31 performs the perspective correction to obtain a front body image by performing the perspective projection transformation on the basis of the body region detected in step S21. Note that it is possible to execute the processing in step S22 and the processing in step S23 in parallel after the processing in step S21.

In step S24, after the local information processor 31 executes image processing for combining the front face image generated in step S22 and the front body image generated in step S23, the processing is terminated. For example, when the image processing for combining the front face image and the front body image is executed by image stitching (image stitching), it is possible to reduce the calculation amount by using positional information of the face region and the body region. Furthermore, by performing image inpainting (image inpainting) when the image processing is executed, for example, it is possible to compensate for an occlusion region.

By executing the person image synthesis processing described above, it is possible for the local information processor 31 to output an image in which the entire body of the user has a posture that faces the front side and the face of the user is captured as facing the front side with high accuracy with a small calculation amount. This allows the communication terminal 13 to provide a better user experience in which the users have face-to-face communication as having eye contact with each other.

### Second Processing Example of Person Image Synthesis Processing

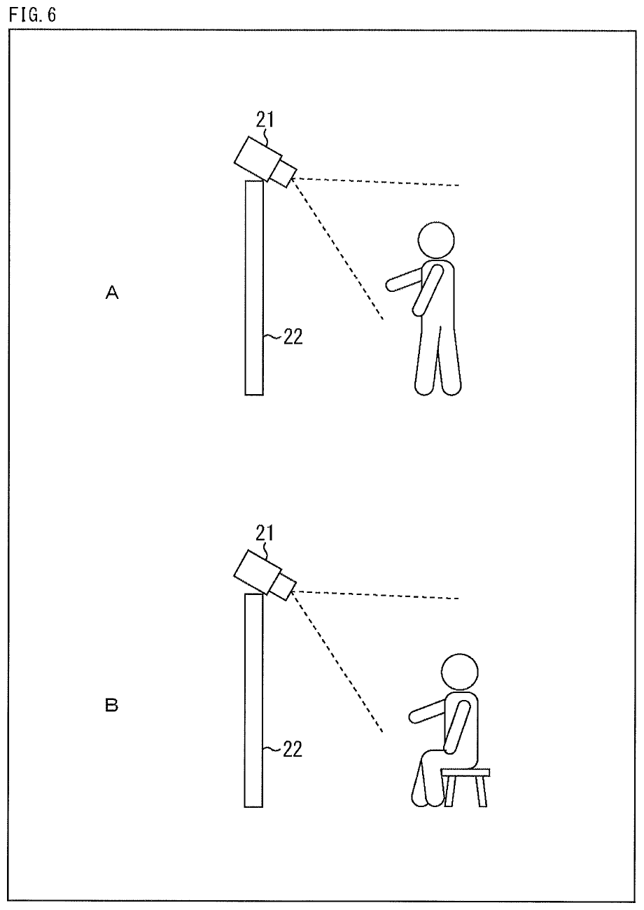

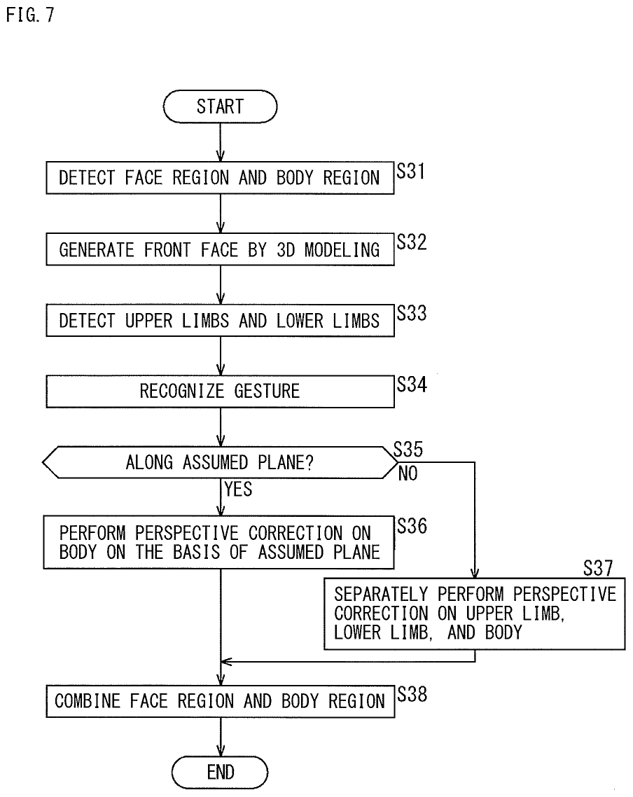

A second processing example of the person image synthesis processing will be described with reference to FIGS. 6 and 7.

For example, as described above with reference to FIG. 4, in a case where the perspective correction is performed as assuming that the body of the user is a plane, for example, if the upper limb or the lower limb is off the body (assumed plane including body), for example, when the user moves hands and feet forward or when the user sits or bends down, an unnatural front body image is formed.

That is, as illustrated in A of FIG. 6, in a case where the user moves one hand forward and makes a gesture like handshake, the one hand is off the assumed plane of the body. Furthermore, as illustrated in B of FIG. 6, in a case where the user sits on a chair and the like, the feet of the user are off the assumed plane of the body.

In this way, in a case where the upper limb or the lower limb of the user is off the assumed plane set to include the body of the user, it is possible to execute the following image processing. In the image processing, the upper limb or the lower limb is assumed as a bar and the perspective correction is performed on the upper limb or the lower limb separately from the body, and thereafter, the corrected upper limb or the lower limb is combined with the body. For example, in a case where a gesture of the user is recognized and the user's gesture is a specific gesture in which the upper limb or the lower limb is off the assumed plane of the body, it is possible to obtain a more natural front body image by separately performing the perspective correction on the upper limb, the lower limb, and the body. Specifically, in a case where a gesture of handshake is recognized, it is possible to execute image processing in which perspective correction is performed on the hand used to shake hands, separately from the body.

FIG. 7 is a flowchart for explaining the second processing example of the person image synthesis processing executed in step S12 in FIG. 3.

In steps S31 and S32, processing similar to the processing in steps S21 and S22 in FIG. 5 is executed. In step S33, the local information processor 31 detects the upper limbs and lower limbs of the user from the body region detected in step S31.

In step S34, the local information processor 31 recognizes a gesture of the user on the basis of the upper limbs and the lower limbs detected in step S33. Then, in a case where a specific gesture in which the upper limb or the lower limb is off the assumed plane of the body is made, the local information processor 31 recognizes that such a specific gesture is made.

In step S35, the local information processor 31 determines whether or not the upper limb or the lower limb of the user is along the assumed plane set to include the body of the user. For example, in a case where the specific gesture is recognized in step S34, the local information processor 31 determines that the upper limb or the lower limb of the user is not along the assumed plane set to include the body of the user.

In a case where the local information processor 31 determines in step S35 that the upper limb or the lower limb of the user is along the assumed plane set to include the body of the user, the processing proceeds to step S36. In step S36, the local information processor 31 performs the perspective correction on the upper limb, the lower limb, and the body on the basis of the assumed plane set to include the body of the user as in step S23 in FIG. 5.

Furthermore, in a case where the local information processor 31 determines in step S35 that the upper limb or the lower limb of the user is not along the assumed plane set to include the body of the user, the processing proceeds to step S37. In step S37, the local information processor 31 separately performs the perspective correction on the upper limb, the lower limb, and the body. Note that, in this case, the perspective correction may be separately performed only on the upper limb or the lower limb that is determined as not being along the assumed plane. For example, as described above, in a case where the gesture of handshake is recognized, the perspective correction may be separately performed only on the hand to be used to shake hands.

After the processing in step S36 or step S37, the processing proceeds to step S38. The local information processor 31 executes the image processing for combining the front face image and the front body image as in step S24 in FIG. 5. Thereafter, the processing is terminated.

By executing the person image synthesis processing described above, even when the user has a posture in which hands, feet, or the like are moved forward, it is possible for the local information processor 31 to avoid executing unnatural image processing. For example, in a case where the user makes a gesture like handshake, if the perspective correction is performed on the hand to be used to shake hands on the assumed plane set to include the body of the user, the unnatural image processing is executed such as processing in which the hand moved forward is looked long. Whereas, by separately performing the perspective correction on the hand when such a gesture is recognized, it is possible to execute the image processing to obtain a more natural image.

### Third Processing Example of Person Image Synthesis Processing

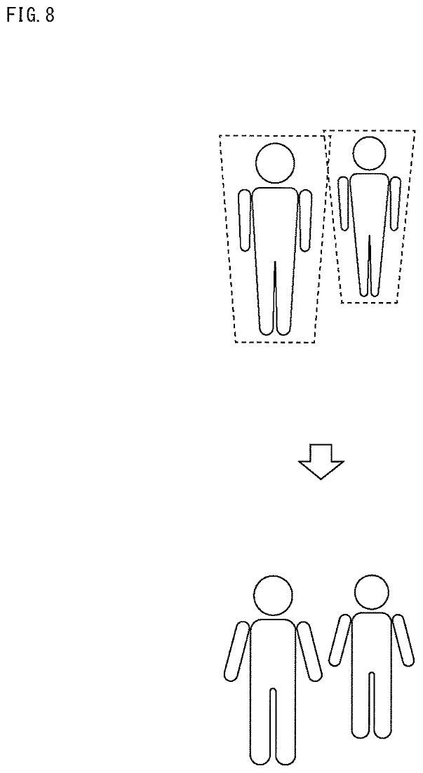

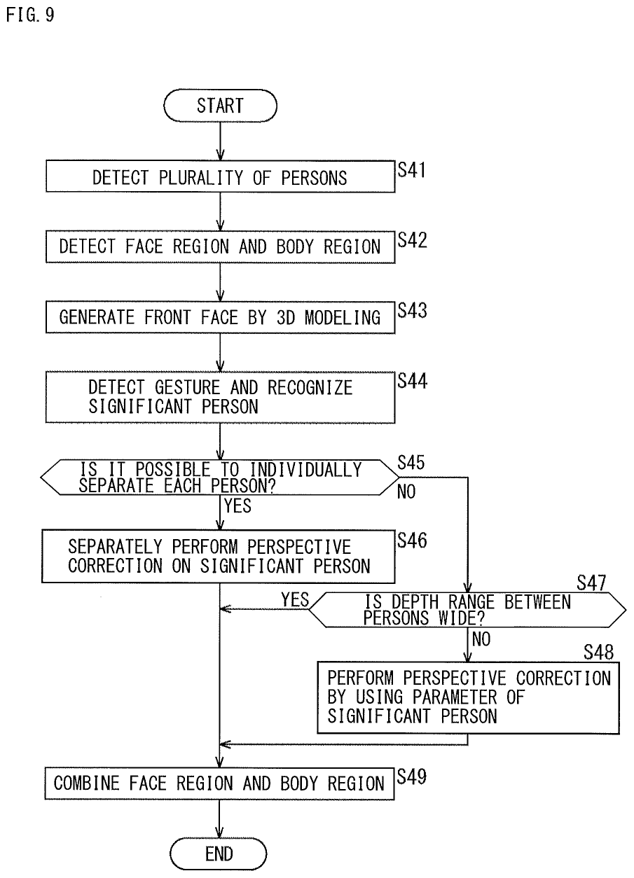

A third processing example of the person image synthesis processing will be described with reference to FIGS. 8 and 9.

For example, as illustrated on an upper side of FIG. 8, in a case where it is possible to individually separate each person from other person in an image in which a plurality of persons (two in example in FIG. 8) is imaged, it is possible to perform the perspective correction for each person. This makes it possible to execute the image processing for synthesizing the images in which the entire body has a posture that faces the front side and the face of the user is captured as facing the front side with high accuracy for each person as illustrated on a lower side of FIG. 8.

Furthermore, for example, in a case where it is not possible to recognize a significant person by detecting a gesture from among the plurality of persons and to individually separate each person from other persons, the perspective correction may be performed on the plurality of persons by using a parameter used for perspective correction on the significant person. Furthermore, for example, a person at the center of the plurality of persons may be recognized as the significant person, or a person who is having a conversation may be recognized as the significant person.

At this time, depth information in a region where each person is captured is acquired. When a depth range is narrow, it is possible to perform the perspective correction using the parameter of the significant person. Note that, in a case where the depth range is wide, fallback may be performed without performing the perspective correction.

FIG. 9 is a flowchart for explaining the third processing example of the person image synthesis processing executed in step S12 in FIG. 3.

In step S41, the local information processor 31 detects a plurality of persons captured in the image based on the image signal supplied from the sensor unit 21.

In steps S42 and S43, processing similar to the processing in steps S21 and S22 in FIG. 5 is executed. In step S44, the local information processor 31 detects a gesture of each of the plurality of persons detected in step S41 and recognizes a significant person from among the detected persons.

In step S45, the local information processor 31 determines whether or not it is possible to individually separate each of the plurality of persons on the basis of a rate of a superimposed portion of the body regions of the plurality of persons. For example, when a rate of the superimposed portion of the body regions of two persons is less than a predetermined rate (for example, 30 percent), it is possible for the local information processor 31 to determine that it is possible to individually separate the two persons from each other.

In a case where it is determined in step S45 that it is possible to individually separate the two persons from each other, the processing proceeds to step S46, and the perspective correction is separately performed on the body regions of the significant person recognized in step S44 and other persons.

Furthermore, in a case where it is determined in step S45 that it is not possible to individually separate the persons from each other, the processing proceeds to step S47.

In step S47, the local information processor 31 determines whether or not a depth range from the closest person to the farthest person among the plurality of persons detected in step S41 is wider than a specified range. Here, the specified range to be a reference of the determination is a depth range that does not cause feeling of discomfort even when the perspective correction is performed on the body regions of the persons by using a single parameter.

In a case where it is determined in step S47 that the depth range is not wider than the specified range, the processing proceeds to step S48, and the local information processor 31 performs the perspective correction on the body regions of the multiple persons by using the parameter used to perform the perspective correction on the body region of the significant person.

In a case where it is determined in step S47 that the depth range is wider than the specified range after the processing in step S46 or after the processing in step S48, the processing proceeds to step S49.

In step S49, the local information processor 31 executes image processing for combining the face region and the body region of each of the plurality of persons. After the processing in step S49, the processing is terminated.

By executing the person image synthesis processing described above, it is possible for the local information processor 31 to output an image in which the entire body of each of the plurality of persons has a posture that faces the front side and the face of the user is captured as facing the front side with high accuracy with a small calculation amount.

Note that the imaging device included in the sensor unit 21 is not limited to the imaging device disposed on the upper side of the display included in the presentation unit 22 and may be disposed on the side such as the right side or the left side of the display. It is sufficient that the imaging unit be disposed to image the user who faces the front side of the display from a direction other than the front side.

### EXAMPLE OF CONFIGURATION OF COMPUTER

Note that each processing described with reference to the flowcharts described above is not necessarily executed in time series along an order described in the flowchart and includes processing executed in parallel or processing that is separately executed (for example, parallel processing or processing by object). Furthermore, a program may be processed by a single CPU or may be distributed and processed by a plurality of CPUs. Furthermore, as used herein, the system represents an entire apparatus including a plurality of devices.

Furthermore, it is possible to execute the series of processing (image processing method) described above by hardware or software. In a case where the software executes the series of processing, a program included in the software is installed from a program recording medium in which the program is recorded to a computer incorporated in dedicated hardware or, for example, a general-purpose computer and the like that is able to execute various functions by installing various programs.

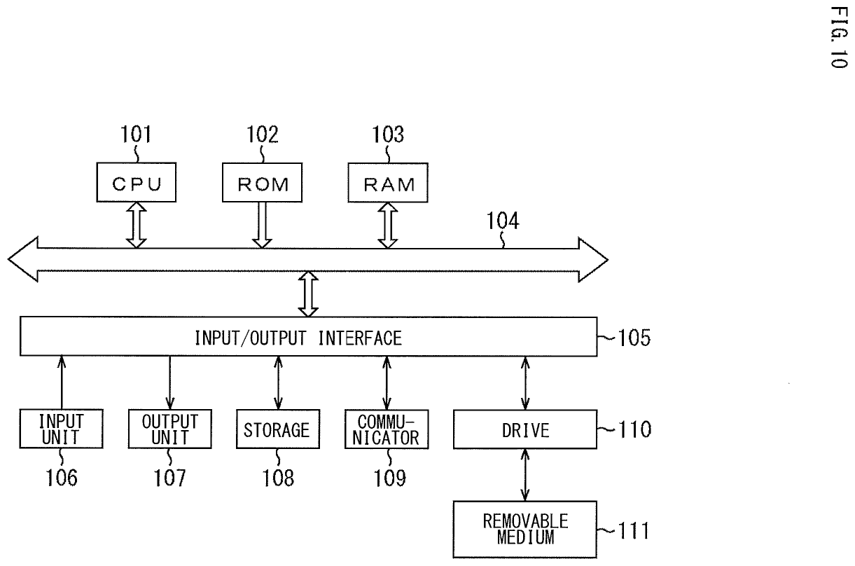

FIG. 10 is a block diagram illustrating an example of a configuration of hardware of a computer that executes the series of processing by a program.

In the computer, CPU (Central Processing Unit) 101, ROM (Read Only Memory) 102, and RAM (Random Access Memory) 103 are coupled to each other by a bus 104.

The bus 104 is further coupled to an input/output interface 105. The input/output interface 105 is connected to an input unit 106 including a keyboard, a mouse, a microphone, and the like, an output unit 107 including a display, a speaker, and the like, a storage 108 including a hard disk, a non-volatile memory, and the like, a communicator 109 including a network interface and the like, and a drive 110 that drives a removable medium 111 such as a magnetic disk, an optical disk, a magnet-optical disk, or a semiconductor memory.

The computer configured as described above executes the series of processing, for example, by loading a program stored in the storage 108 to the RAM 103 via the input/output interface 105 and the bus 104 and executing the program by the CPU 101.

For example, the program executed by the computer (CPU 101) is provided by recording the program in the removable medium 111 that is a package medium including a magnetic disk (including flexible disk), an optical disk (CD-ROM (Compact Disc-Read Only Memory), DVD (Digital Versatile Disc), and the like), a magnet-optical disk, a semiconductor memory, or the like or via a wired or wireless transmission medium such as a local area network, the Internet, or digital satellite broadcasting.

Then, it is possible to install the program to the storage 108 via the input/output interface 105 by attaching the removable medium 111 to the drive 110. Furthermore, it is possible to cause the program to be received by the communicator 109 via the wired or wireless transmission medium and to be installed to the storage 108. In addition, it is possible to install the program to the ROM 102 and the storage 108 in advance.

### EXAMPLE OF COMBINATION OF CONFIGURATIONS

Note that it is possible for the technology to have the following configuration.

(1)

An image processing apparatus including:

a detector that detects, from an image obtained by imaging of a user who faces a front side of a display unit by an imaging unit from a direction other than the front side, a face region in which a face of the user is captured and a body region in which a body of the user is captured, the display unit being configured to display an image;

a front face generator that generates, on the basis of the face region, a front face image in which the face of the user is imaged from the front side;

a body corrector that performs, on the basis of the body region, correction into a front body image in which the body of the user is imaged from the front side; and

a combination unit that combines the front face image and the front body image.

(2)

The image processing apparatus according to (1), in which the front face generator generates the front face image by attaching a texture of the face of the user, after creating, from the face region, a 3D model of the face of the user and executing rotation processing on the 3D model in such a manner as to face the front side.

(3)

The image processing apparatus according to (1) or (2), in which the body corrector obtains the front body image by performing perspective projection transformation on the body region.

(4)

The image processing apparatus according to (3), in which, in a case where a plane including the body of the user is assumed and an upper limb or a lower limb of the user is not along the plane, the body corrector corrects the upper limb or the lower limb separately from the body region.

(5)

The image processing apparatus according to any one of (1) to (4), in which, in a case where a plurality of persons is captured in the image imaged by the imaging unit, the body corrector separately corrects the body region of each of the persons.

(6)

The image processing apparatus according to any one of (1) to (4), in which, in a case where a plurality of persons is captured in the image imaged by the imaging unit, the body corrector corrects the body regions of all the persons by using a parameter used to correct the body region of a specific person in the persons.

(7)

An image processing method performed by an image processing apparatus that processes, in remote communication through which an image is subjected to transmission and reception, the image, the image processing method including:

detecting, from an image obtained by imaging of a user who faces a front side of a display unit by an imaging unit from a direction other than the front side, a face region in which a face of the user is captured and a body region in which a body of the user is captured, the display unit being configured to display an image;

generating, on the basis of the face region, a front face image in which the face of the user is imaged from the front side;

performing, on the basis of the body region, correction into a front body image in which the body of the user is imaged from the front side; and

combining the front face image and the front body image.

(8)

A program that causes a computer of an image processing apparatus to execute image processing, the image processing apparatus processing, in remote communication through which an image is subjected to transmission and reception, the image, the image processing including:

detecting, from an image obtained by imaging of a user who faces a front side of a display unit by an imaging unit from a direction other than the front side, a face region in which a face of the user is captured and a body region in which a body of the user is captured, the display unit being configured to display an image;

generating, on the basis of the face region, a front face image in which the face of the user is imaged from the front side;

performing, on the basis of the body region, correction into a front body image in which the body of the user is imaged from the front side; and

combining the front face image and the front body image.

(9)

A remote communication system including:

a communication unit that performs transmission and reception of at least an image with a partner of a communication;

a display unit that displays the image transmitted from a side of the partner;

an imaging unit that performs imaging of a user who faces a front side of the display unit from a direction other than the front side;

a detector that detects, from an image obtained by the imaging of the user by the imaging unit, a face region in which a face of the user is captured and a body region in which a body of the user is captured;

a front face generator that generates, on the basis of the face region, a front face image in which the face of the user is imaged from the front side;

a body corrector that performs, on the basis of the body region, correction into a front body image in which the body of the user is imaged from the front side; and

a combination unit that combines the front face image and the front body image.

Note that the embodiment is not limited to the embodiment described above and can be variously changed without departing from the gist of the present disclosure. Furthermore, the effects described here are merely examples and not limited, and other effects may be obtained.

### REFERENCE SIGNS LIST

11: Remote communication system
12: Network
13: Communication terminal
21: Sensor unit
22: Presentation unit
23: Communication processor
31: Local information processor
32: Encoder
33: Transmitter
34: Receiver
35: Decoder
36: Remote information processor

1. An image processing apparatus comprising:
a detector that detects, from an image obtained by imaging of a user who faces a front side of a display unit by an imaging unit from a direction other than the front side, a face region in which a face of the user is captured and a body region in which a body of the user is captured, the display unit being configured to display an image;
a front face generator that generates, on a basis of the face region, a front face image in which the face of the user is imaged from the front side;
a body corrector that performs, on a basis of the body region, correction into a front body image in which the body of the user is imaged from the front side; and
a combination unit that combines the front face image and the front body image.

2. The image processing apparatus according to claim 1, wherein the front face generator generates the front face image by attaching a texture of the face of the user, after creating, from the face region, a 3D model of the face of the user and executing rotation processing on the 3D model in such a manner as to face the front side.

3. The image processing apparatus according to claim 1, wherein the body corrector obtains the front body image by performing perspective projection transformation on the body region.

4. The image processing apparatus according to claim 3, wherein, in a case where a plane including the body of the user is assumed and an upper limb or a lower limb of the user is not along the plane, the body corrector corrects the upper limb or the lower limb separately from the body region.

5. The image processing apparatus according to claim 1, wherein, in a case where a plurality of persons is captured in the image imaged by the imaging unit, the body corrector separately corrects the body region of each of the persons.

6. The image processing apparatus according to claim 1, wherein, in a case where a plurality of persons is captured in the image imaged by the imaging unit, the body corrector corrects the body regions of all the persons by using a parameter used to correct the body region of a specific person in the persons.

7. An image processing method performed by an image processing apparatus that processes, in remote communication through which an image is subjected to transmission and reception, the image, the image processing method comprising:
detecting, from an image obtained by imaging of a user who faces a front side of a display unit by an imaging unit from a direction other than the front side, a face region in which a face of the user is captured and a body region in which a body of the user is captured, the display unit being configured to display an image;
generating, on a basis of the face region, a front face image in which the face of the user is imaged from the front side;
performing, on a basis of the body region, correction into a front body image in which the body of the user is imaged from the front side; and
combining the front face image and the front body image.

8. A program that causes a computer of an image processing apparatus to execute image processing, the image processing apparatus processing, in remote communication through which an image is subjected to transmission and reception, the image, the image processing comprising:
detecting, from an image obtained by imaging of a user who faces a front side of a display unit by an imaging unit from a direction other than the front side, a face region in which a face of the user is captured and a body region in which a body of the user is captured, the display unit being configured to display an image;
generating, on a basis of the face region, a front face image in which the face of the user is imaged from the front side;
performing, on a basis of the body region, correction into a front body image in which the body of the user is imaged from the front side; and
combining the front face image and the front body image.

9. A remote communication system comprising:
a communication unit that performs transmission and reception of at least an image with a partner of a communication;
a display unit that displays the image transmitted from a side of the partner;
an imaging unit that performs imaging of a user who faces a front side of the display unit from a direction other than the front side;
a detector that detects, from an image obtained by the imaging of the user by the imaging unit, a face region in which a face of the user is captured and a body region in which a body of the user is captured;
a front face generator that generates, on a basis of the face region, a front face image in which the face of the user is imaged from the front side;
a body corrector that performs, on a basis of the body region, correction into a front body image in which the body of the user is imaged from the front side; and
a combination unit that combines the front face image and the front body image.
